(19) United States
(12) Patent Application Publication
(10) Pub. No.: US 2021/0049240 A1
(43) Pub. Date: Feb. 18, 2021

(54) HIGHLY AVAILABLE POLICY AGENT FOR BACKUP AND RESTORE OPERATIONS

(71) Applicant: EMC CORPORATION, (US)

(72) Inventors: Min-Chih L. Earl, Redmond, WA (US); Matthew D. Buchman, Seattle, WA (US); Jerzy Gruszka, Lacey, WA (US)

(73) Assignee: EMC CORPORATION, Hopkinton, MA (US)

(21) Appl. No.: 13/800,708

(22) Filed: Mar. 13, 2013

(51) Int. Cl. G06F 17/30

(52) U.S. Cl. CPC G06F 17/30008

(57) ABSTRACT

In one example, a method is directed to defining and applying policies for backing up virtual machines in a cluster environment. One or more user input parameters are used to define a set of policies for a backup, and the policies in turn form the basis for development of a backup workflow which can then be scheduled and implemented according to the schedule.

### RELATED APPLICATIONS

This application is related to U.S. patent application Ser. No. 13/799,696, filed Mar. 13, 2013, entitled HIGHLY AVAILABLE CLUSTER AGENT FOR BACKUP AND RESTORE OPERATIONS. The aforementioned application is incorporated herein in its entirety by this reference.

### FIELD OF THE INVENTION

Embodiments of the present invention relate to backing up and restoring data. More particularly, embodiments of the invention relate to systems and methods for orchestrating the backup and restoration of elements such as virtual machines in cluster environments.

### BACKGROUND

In conventional systems, data is often backed up by simply making a copy of the source data. To make this process more efficient, snapshot technologies have been developed that provide additional versatility to both backing up data and restoring data. Using snapshots, it is possible to backup data in a manner than allows the data to be restored at various points in time.

Because there is a need to have reliable data and to have that data available in real-time, emphasis is placed on systems that can accommodate failures that impact data. As computing technologies and hardware configurations change, there is a corresponding need to develop backup and restore operations that can accommodate the changes.

Cluster technologies (clusters) are examples of systems where reliable backup and restore processes are needed. Clusters provide highly available data, but are difficult to backup and restore for various reasons. For example, clusters often include virtualized environments. Nodes in the cluster can host virtual machines. When a portion (e.g., a virtual machine operating on a node) of a cluster fails, the cluster is able to make the data previously managed by that virtual machine available at another location in the cluster, often on another node. Unfortunately, the failover process can complicate the backup and restore operations.

More specifically, clusters often include cluster shared volumes (CSVs). Essentially, a CSV is a volume that can be shared by multiple nodes and by multiple machines. The inclusion of CSVs plays a part in enabling high availability. Because all nodes can access the CSVs, virtual machines instantiated on the nodes can migrate from one node to another node transparently to users.

In order to successfully backup a virtual machine that uses a CSV, it is necessary to have access to configuration information including the virtual hard disk of the virtual machine. Conventionally, tracking which virtual machines are on which nodes and ensuring that the configuration data is current is a complex process. Knowing the node address, for example, may not result in a successful backup since the virtual machines can migrate to other nodes in the cluster.

More generally, the ability of virtual machines to migrate within a cluster can complicate the backup and restore processes and make it difficult to correctly determine configuration information for the virtual machines when backing up or restoring a virtual machine.

A related problem concerns the fact that in a cluster environment, there may be numerous, possibly hundreds for example, virtual machines per node. Given the fact that there could also be numerous nodes in a cluster, a given cluster may include possibly thousands of virtual machines. With so many virtual machines, it may be quite difficult to conduct the backup of the virtual machines, which could involve a significant amount of data, during the backup timeframe that is available. Moreover, the resources available for data backup may be inadequate in any event.

To illustrate, the backup of data may involve the use of a backup application that requires an administrator to schedule the backup. In some instances at least, the administrator may not have the information necessary to effectively implement the backup. For example, the administrator may not have knowledge of, and/or access to, all of the data that should be backed up. As another example, the administrator may not have knowledge of, and/or access to, all of the clusters that include data that should be backed up. Given the often incomplete state of the knowledge of the administrator, it may be difficult to perform an adequate backup.

### BRIEF DESCRIPTION OF THE DRAWINGS

The appended drawings contain figures of example embodiments to further illustrate and clarify various aspects of the present invention. It will be appreciated that these drawings depict only example embodiments of the invention and are not intended to limit its scope in any way. Aspects of the invention will be described and explained with additional specificity and detail through the use of the accompanying drawings in which:

FIG. 1 illustrates a block diagram of an example of a cluster environment and of a backup system configured to backup and restore virtual machines operating in the cluster environment;

FIG. 2 illustrates an example of a method for backing up a virtual machine in a cluster environment;

FIG. 3 illustrates an example of a method for restoring a virtual machine in a cluster environment;

FIG. 4 is a block diagram of an example of a cluster environment, policy engine and backup system configured to backup and restore virtual machines operating in the cluster environment;

FIG. 5 is a block diagram of an example of a policy engine; and

FIG. 6 is a flow diagram of an example method for operation of a policy engine and associated backup process.

### DETAILED DESCRIPTION OF SOME EXAMPLE EMBODIMENTS

Embodiments of the present invention generally concern backup and recovery of data. More particularly, at least some embodiments of the invention concern systems and methods for orchestration of data backup in a cluster environment. Among other things, such orchestration may improve the efficiency and effectiveness of backup operations. As well, orchestration of data backup may facilitate scalability of the environment(s) in which the backup is performed.

A computer cluster (cluster) is a group of devices that are configured to work together. The cluster typically includes one or more computing devices. Each computing device may be a node of the cluster. Each node may be, by way of example only, a server computer running server software or other computing device. Each node may also be configured with a virtual machine manager (VMM) or a hypervisor layer that enables one or more virtual machines to be implemented on each node.

A cluster can provide high availability and typically provides improved performance compared to a stand-alone computer. A cluster has the ability, for example, to adapt to problems that may occur with the virtual machines operating therein. For example, when a node fails, the cluster provides a failover procedure that enables another node to take over for the failed node. Virtual machines or operations of the virtual machines on the failed node may be taken up by other virtual machines on other nodes.

A cluster may also include cluster resources. Cluster resources exist on nodes in the cluster and can migrate between nodes in the cluster. A cluster resource can be a physical resource, a software resource or the like that can be owned by a node. Often, the cluster resource is owned by one node at a time. In addition, the cluster resource can be managed in the cluster, taken online and/or offline. Further, a cluster resource may also abstract the service being provided to the cluster. As a result, the cluster only understands that a cluster resource is available and can be used by any node in the cluster. A cluster resource is typically used by one node at a time and ownership of the cluster resource belongs to the node using the cluster resource. A cluster resource may have its own IP address and name, for example.

Virtual machines, which are also a type of cluster resource, in a CSV environment can migrate from node to node as previously stated. Advantageously, embodiments of the invention enable backup and restore processes to occur without requiring the backup server to know where the virtual machine resides during the backup interval. The cluster resource is configured to interface with the backup server and with a local agent operating on a node in the cluster.

By involving a cluster resource that has a network name and an IP address in the backup and restore operations, a backup server can contact the cluster resource without knowing any of the cluster node names or address. In addition, the cluster resource can also migrate from node to node and thereby provides high availability for backup and restore operations.

Bearing the foregoing in mind, example embodiments of the invention relate to a policy engine that may be employed in various environments, one example of which is the cluster environment just described. In some embodiments, the policy engine may be an element of a cluster agent. The policy engine may employ a variety of types of information in the definition of one or more backup policies. This information may be generally referred to herein as input parameters, and can be generated by the policy engine itself and/or collected and/or received from one or more other sources.

Information collected from other sources can include, for example, information about the configuration and/or state of various components of the cluster. Another example of such information is information concerning any constraints that may relate to performance of the backup. Such constraints may be of a physical, temporal, and/or other nature.

Some embodiments of the invention are directed to a policy engine that may also be configured to receive input, from an administrator for example, that may further define and/or refine the backup or backups to be performed. Such input may include, for example, the amount of time allotted for performance of a backup or backups, the time when the backup(s) should commence, the number of allowed parallel backup streams, and/or any other input relating to performance of a backup.

Once the policy engine has all the information concerning a particular backup to be performed, the policy engine can then generate a backup workflow. A backup workflow generated by the policy engine may include, for example, a sequence of processes to be performed, for example, by a cluster agent.

In at least some instances, the policy engine may evaluate the information to be used in the generation of the backup workflow to identify any conflicts. Such conflicts can be flagged and brought to the attention of an administrator, for example, for adjudication of the conflict. In other instances, the policy engine may include one or more protocols that instruct the policy engine as to how conflicts should be resolved. In this latter example, the involvement of an administrator may not be required.

In addition to generation of a backup workflow, embodiments of the invention may include a policy engine that can implement still other functionality. For example, the policy engine may perform analyses of historical data flow within the cluster. Such analyses may be used, for example, to make predictions about future traffic flow. These predictions can be taken into account when scheduling a backup and/or may form the basis for generation of recommendations to an administrator as to when the backup should, or should not, be performed.

Finally, at least some embodiments of the invention are directed to a policy engine that is able to dynamically adjust the workflow of a backup process ‘on the fly’ to accommodate changes in one or more conditions, such as the failover of a node for example, in the environment where the backup is being performed.

It should be noted that one or more embodiments of the invention are directed to policy engines that may include one, some, or all of the elements and functionality, in any combination, noted in the preceding discussion. Yet other embodiments may include additional, or alternative, elements and functionality. Accordingly, the foregoing discussion is provided solely by way of example and is not intended to limit the scope of the invention in any way.

A. Cluster Agent

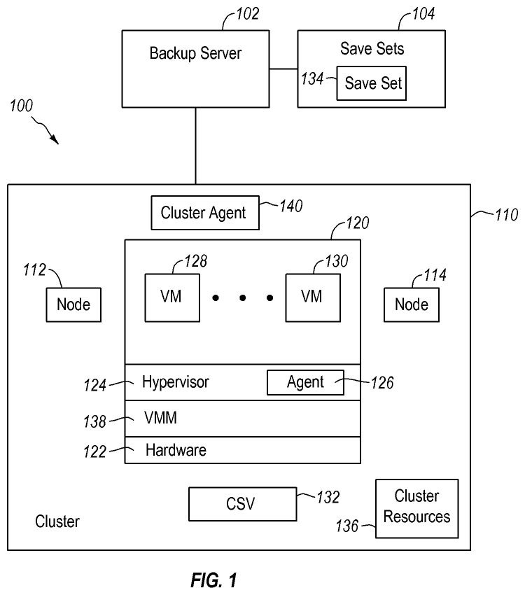

FIG. 1 illustrates an example of a computer system 100. The computer system 100 illustrated in FIG. 1 may include one or more networks or network configurations. The computer system 100 includes storage configured to store data of varying types (e.g., applications, email, video, image, text, database, user data, documents, spreadsheets, or the like or any combination thereof). The data may exist in the context of a virtualized environment. In the computer system 100, the data or a portion thereof or a virtual machine including the virtual machines virtual hard disk can be backed up and restored by a backup server 102. The backup of the data may be continuous, periodically, on a requested or scheduled basis. The backup server 102 generates save sets 104 when performing backups. The save sets 104 correspond, in one example, to the virtual machines in the computer system 100.

The computer system 100 includes a computer cluster 110 (cluster 110). The cluster 110 includes one or more nodes, illustrated as node 112, node 114 and node 120. Each node includes or is associated with hardware. The node 120 is associated with hardware 122 in this example. The hardware 122 can include processors, network adapters, memory of various types, caches, and other chips that may be used in enabling the operation of the hardware 122. The hardware 122 may be a computing device running an operating system (e.g., a server computer) that is capable of supporting virtual machines.

In this example, the hardware 122 is configured to support the operation of the cluster 110. In the cluster 110, the nodes 112, 114, and 120 may each be associated with different hardware (e.g., each node may be a distinct or separate computing device). Alternatively, the nodes 112, 114, and 120 may be configured such that the hardware is shared or such that certain hardware, such as a hard disk drive, is shared. The nodes 112, 114, and 120 or the virtual machines instantiated thereon may utilize the same storage, processor group, network adapter, or the like or any combination thereof.

The hardware 122 of the cluster 110 may include one or more cluster shared volumes (CSVs). The CSV 132 is an example of a cluster shared volume. The CSV 132 is a volume configured such that more than one virtual machine (discussed below) can use the same physical disk even if not on the same node. In addition, the virtual machines that may be using the CSV 132 can move to different nodes (e.g., during failover or for another reason) independently of each other. In one example, the various virtual machines operating in the cluster 110 can move from or transfer one node to another node for different reasons.

FIG. 1 further illustrates that a virtual machine manager (VMM) 138 and a hypervisor 124 are installed on or are operating on the node 120. The hypervisor 124 and the VMM 138 are typically software that cooperate to create and manage virtual machines on a host machine or on host hardware such as the hardware 122 of the node 120. Each of the nodes 112 and 114 may also include a hypervisor 124 and a VMM 138. The hypervisor 124 operates to abstract the hardware 122 in order to instantiate virtual machines.

In FIG. 1, the node 120 supports virtual machines represented as virtual machines 128 and virtual machine 130. Each virtual machine 128 and 130 may include or be associated with one or more virtual hard disks. Although reference is made to virtual hard disks, one of skill in the art can appreciate that other formats may be used. A virtual hard disk may be, in one example, a file that is configured to be used as a disk drive for a virtual machine or that is a representation of a virtual machine. In one example, the virtual machines 128 and/or 130 can be encapsulated in a file or in a file structure. The virtual hard disk of the virtual machine 128 and the virtual hard disk of the virtual machine 130 may both reside on the CSV 132.

FIG. 1 further illustrates the backup server 102. The backup server 102 may communicate with the cluster 110. The backup server 102 is configured to generate save sets 104. The save set 134 is an example of a save set. Each save set in the save sets 104 may be a backup of one or more of the virtual machines operating in the cluster 110 as previously stated.

In this example, the save set 134 may be a backup of the virtual machine 128. The save sets 104 in general correspond to backups of the virtual machines in the cluster 110. The save sets may be configured such that the virtual machines (e.g., the virtual machines 128 and 130) can be restored at any point in a given time period. Embodiments of the invention also enable the save set 134 to be restored at a location that may be different from the location at which the backup was performed. For example, a backup of the virtual machine 128 may be restored to the node 112, to another cluster, or to a stand-alone machine.

FIG. 1 further illustrates a cluster agent 140, which is an example of a cluster resource 136. The cluster agent 140 may also be a cluster group. A backup of the virtual machine 128 (or portion thereof) or of the cluster 110 can be initiated in various ways (e.g., periodically, on request, or the like). The command or work order, however, typically begins when the work order is received by the cluster agent 140.

The cluster agent 140 can coordinate with a local agent 126 when performing a backup or a restore. Advantageously, this relieves the backup server 102 from knowing which nodes are associated with which virtual machines and provides transparency from a user perspective. Because the cluster agent 140 may be a cluster resource, the cluster agent 140 can independently operate in the cluster 140 to query the cluster to locate and interact with various virtual machines as necessary.

In one example, the cluster agent 140 represents the cluster 110 as a single entity even when there are multiple nodes in the cluster 110. In this sense, the backup or restore of a virtual machine can proceed as if the backup server were backing up a single node. The cluster agent 140 is configured to manage the virtual machines and handle migration of the virtual machines transparently to a user. Further, the cluster agent 140 is highly available to perform operations in the CSV cluster environment. As previously stated, the backup server 102 can communicate with the cluster agent 140 regardless of where the cluster agent 140 is running since the cluster agent has its own network name and IP address. The cluster agent 140 can access and manage cluster virtual machines independently the locations of the virtual machines' resources.

The cluster agent 140 is configured as a highly available cluster resource is able to tolerate node failure and is capable of migrating to an online node when necessary. This ensures that the cluster agent 140 is highly available for backup and restore operations.

In one example, a single local agent 126 can be instantiated on one of the nodes. The local agent 126 can receives commands or work orders from the cluster agent 140 and can coordinate a backup or restore of any virtual machines owned by the node on which the local agent 126 is installed. Further, the cluster agent 140 can operate on any of the nodes in the cluster 110. Alternatively, each node in the cluster 110 may be associated with a local agent and each local agent may be able to coordinate with the cluster agent 140.

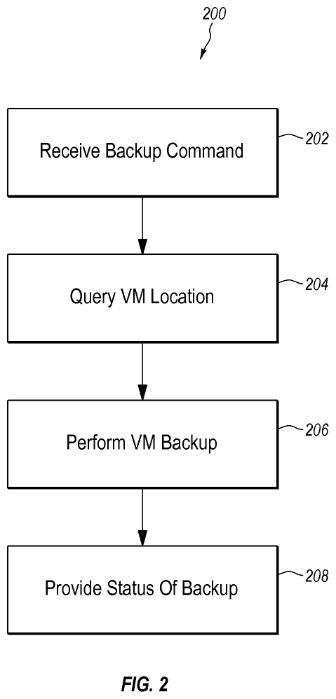

FIG. 2 illustrates a method for performing a backup of a virtual machine in an environment such as a cluster. The method 200 may begin when a backup server calls for backup or issues a command (e.g., a workorder) for backup in block 202. The call or command for backup may be delivered to and received by the cluster agent in block 202. The command may identify the virtual machine to be backed up. However, the backup server may not know the location of the virtual machine or on which node the virtual machine is operating.

In block 204, the cluster agent can query the cluster to determine the location of the virtual machined identified in the workorder. Because the cluster agent is running as a cluster-wide resource, the cluster agent can query the location of the virtual machine. Once the location of the virtual machine is determined, the backup of the virtual machine is performed in block 206.

When a backup of the virtual machine is performed, configuration data of the virtual machine and/or the cluster may be included in the save set. This facilitates the restoration of the virtual machine when a redirected restore or other restore is performed.

The backup of the virtual machine may be handled by the cluster agent itself. Alternatively, the cluster agent may coordinate with a local agent and the local agent may coordinate the backup of the virtual machine. In one example, the local agent may reside on the same node as the virtual machine being backed up. When backing up the virtual machine, the local agent may ensure that a snapshot is taken of the virtual machine or of the CSV used by the virtual machine. By taking a snapshot of the CSV, the virtual machine can be properly backed up.

The local agent may interface with a local service (e.g., a snapshot service) to ensure that a snapshot of the virtual machine is performed during the backup procedure. The snapshot may be performed by the cluster or by the relevant node in the cluster or by the local agent in conjunction with the local snapshot service. The snapshot may be stored in a snapshot directory. At the same time, the configuration information may also be included in the save set of the virtual machine, which is an example of a backup of the virtual machine.

Once the backup is completed, the local agent provides a corresponding status to the cluster agent in block 208. The cluster agent may also provide the status to the backup server as well. The cluster agent may consolidate the backup status sent from each cluster node and report the backup status from each node back to the backup server.

Because the location of the virtual machine is determined at the time of performing the backup by the cluster agent, the backup operation is not adversely affected if the virtual machine migrates to another node between the time that the backup of the virtual machine is scheduled and the time at which the backup operation is performed.

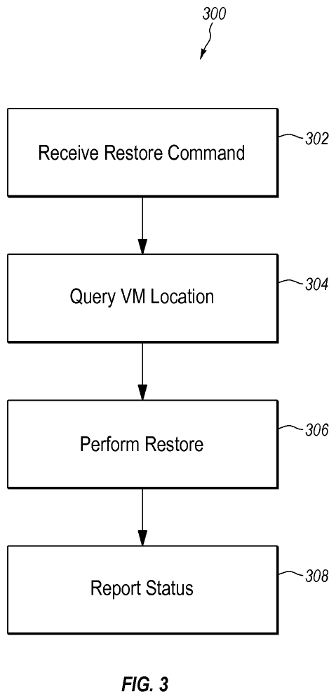

FIG. 3 illustrates an example method for restoring a save set in order to restore a virtual machine. In block 302, a call (e.g., a workorder) for restoring a virtual machine is made. The virtual machine corresponds to a save set. The workorder generally originated with the backup server, which sends the workorder to the cluster agent.

In block 304, the destination of the virtual machine is determined. The destination may depend on whether the virtual machine is still present in the cluster. For example, the cluster agent by locate the current node of the virtual machine and determine that the current node on which the virtual machine is instantiated is the destination of the restore operation. If the virtual machine is no longer available in the cluster, then the node on which the cluster agent is operating may be used as the destination.

One of skill in the art can appreciate that the virtual machine could be restored on another node in light of the ability of the cluster to migrate virtual machines from one node to another. Once the destination is determined, the workorder is sent to the local agent of the appropriate node. Alternatively, for an embodiment that includes a single local agent, the destination node may also be provided to the local agent.

In block 306, the restore is performed. More specifically, the virtual machine is restored to the identified destination. This may include adjusting the restore process to account for changes between the configuration of the node, the virtual machine, and/or the cluster and the configuration included in the save set from which the virtual machine is restored.

For example, the configuration of the destination may be compared with the configuration information that was included with the save set. Adjustments may be made to the save set or to the metadata in order to ensure that the restoration of the virtual machine is compatible with the destination. For example, changes in the directory structure, virtual machine configuration (processor, memory, network adapter), cluster configurations, or the like are accounted for during the restore process.

In block 308, the local agent reports a status of the restore to the cluster agent. The cluster agent may also report a status of the restore to the backup server.

The backup and restore operations discussed herein can be independent of the physical node on which the virtual machine resides.

B. Example Operating Environment and Policy Engines

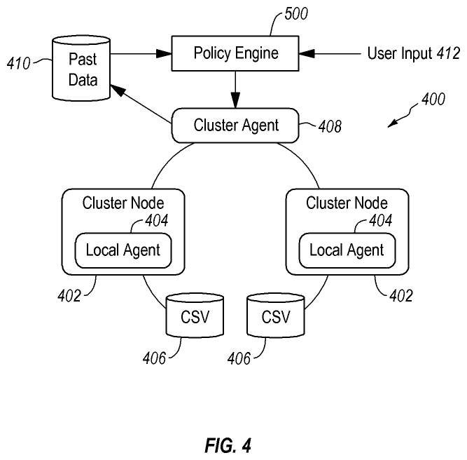

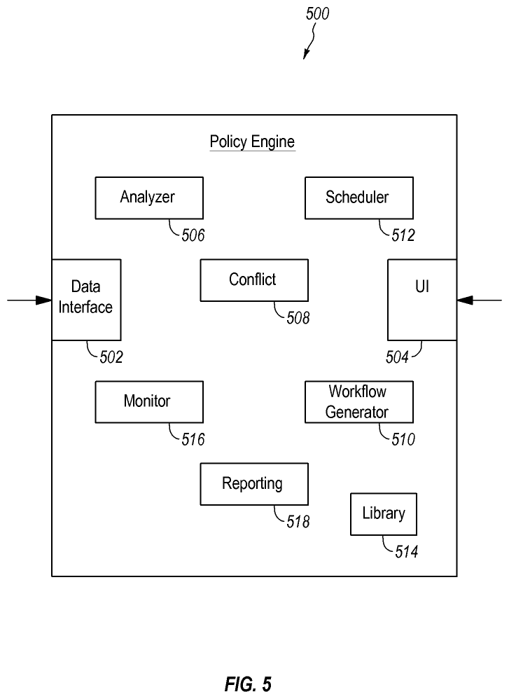

With attention now to FIGS. 4 and 5, details are provided concerning aspects of some example operating environments and policy engines. In general, one or more embodiments of a policy engine may operate in an environment such as that disclosed in FIG. 1 and described above, and a backup associated with the policy engine may be initiated as described above, or elsewhere herein.

A more particular example of an operating environment 400 that may be useful for some implementations of a policy engine is set forth in FIG. 4. As indicated there, the operating environment 400 may take the form of a cluster that includes one or more cluster nodes 402, each of which may include a respective local agent 404. As well, the operating environment 400 may include a one or more CSVs 406 configured for communication with one or more of the cluster nodes 402. A cluster agent 408 is included that may have access to up to date information about the state and configuration of the operating environment 400 and its elements, including the cluster nodes 402 for example.

As well, the cluster agent 408 may be configured to access a database 410 that includes, among other things, historical data relating to one or more previously performed backups. Such historical data may be used, for example, in performance analyses and/or in the definition of one or more workflows and can include, but is not limited to: one or more of the date of a prior backup; the time a prior backup was commenced and/or completed; the identification of the node(s) previously backed up; the type(s) of data previously backed up; the elapsed time required for a prior backup; the amount of data previously backed up; the location(s) of the backed up data; the time and/or date that backed up data was used in a restoration operation; the workflow of a prior backup; one or more input parameters associated with a prior backup; whether and what dynamic adjustments were made to a prior workflow, and the underlying cause(s) for those adjustments; the number and/or identity of parallel backup streams associated with a prior backup; the number, state and/or configuration of one or more cluster elements such as CSVs, cluster nodes, and/or VMs at the time of a prior backup; physical attributes, including cluster disk geometry and/or size; cache hit information; and, any combination of the foregoing. While the foregoing are examples of data that can be stored in, and accessible at, database 410, it should be understood that any combination of the foregoing data types can be stored elsewhere.

With continuing reference to FIG. 4, a policy engine 500 is provided that may, but need not, comprise an element of a cluster resource such as the cluster agent 408. Where the policy engine 500 is not an element of the cluster agent 408, the policy engine 500 may be attached to, or otherwise associated with, a cluster resource such as the cluster agent 408. In any case, the policy engine 500, whether by attachment to, or inclusion in, a cluster resource, may possess the attributes that make a cluster resource (such as cluster resource 136 for example) highly available.

As indicated in FIG. 4, the policy engine 500 may pull, and/or have pushed to it, information of various different types from a variety of different sources, including the database 410 and one or more users 412. Such information may be referred to herein as input parameters and, in general, can be used by the policy engine 500 to perform various operations, including the generation of workflows for one or more data backup processes.

Directing attention now to FIG. 5, details are provided concerning aspects of the example policy engine 500. As generally indicated in FIG. 5, embodiments of a policy engine may include a variety of different modules configured to carry out various functions. It should be noted that the functions indicated in FIG. 5 are provided by way of example and additional, or alternative, functions may be implemented in other embodiments Likewise, the particular allocation of functions to the modules indicated in FIG. 5 is provided by way of example, and the functions set forth there can be allocated in various other ways as well. Moreover, not every module is necessarily employed each time a schedule and/or workflow is generated. For example, and as discussed in more detail below, the policy engine may include a library of previously generated schedules and workflows which may be re-used in certain circumstances, thereby obviating the need for generation of a new schedule and/or workflow in such circumstances. Finally, any module or element of the policy engine may communicate and/or interoperate with any other module(s) and element(s) of the policy engine, even though such relationships may not be specifically illustrated in the Figures.

With more detailed reference now to FIG. 5, the policy engine 500 may include various interfaces by way of which information can be provided to the policy engine 500 for use in generating workflows. For example, the policy engine 500 may include a data interface 502, by way of which the policy engine 500 is able to communicate with a data repository such as database 410 (see FIG. 4). In some instances at least, the policy engine 500 is configured to pull data from a data repository, although in other cases, a data repository may push data to the policy engine 500.

In addition to the data interface 502, the example policy engine 500 may also include a user interface (UI) 504 by way of which a user, such as an administrator for example, may input parameters such as, but not limited to, time allowance to perform a backup, a desired schedule for the backup, and a number of allowed parallel backup streams. As to the latter, some embodiments provide for only one backup stream in a given timeslot, while other embodiments permit a plurality of backup streams in a given timeslot or overlapping timeslots.

Other examples of input parameters, which can be provided by a user or other source and/or collected by the policy engine 500 include, but are not limited to, any combination of: the type of data to be backed up, an amount of data to be backed up, the granularity associated with a particular backup, any of the input parameters addressed above in connection with the discussion of FIGS. 1 through 3, the historical information noted above in the discussion of database 410, the number, state and/or configuration of one or more cluster elements such as CSVs, cluster nodes, and/or VMs, the number of devices, such as VMs for example, that are online and offline, physical attributes, including cluster disk geometry and/or size, and, any combination of the foregoing. Any combination of this information can be collected by and/or provided to the policy engine 500 at any suitable time, including upon request by a user, and before, during and/or after generation of one or both of a backup workflow and backup schedule. As well, and discussed in more detail below, any combination of the aforementioned information can be collected during performance of a backup so as to enable, among other things, dynamic adjustments to the backup process then in progress.

With continued reference now to FIG. 5, the example policy engine 500 may also include an analyzer 506 which can analyze input parameters, such as those noted above for example, and use the analysis of those parameters to develop a set of guidelines for use in the generation of a backup workflow. The generation of backup workflows is addressed in further detail below. As contemplated herein, the guidelines are one specific example of a policy, or set of policies, that can be used to control various aspects of the performance of a backup. Thus, the policies are derived from, and based upon, the input parameters.

In connection with the analysis of the input parameters by the analyzer 506, a conflict module 508 of the policy engine 500 may evaluate the input parameters to identify any conflicts prior to development of a backup schedule and workflow. For example, a conflict may arise if a user enters a time allowance for performance of a backup, but the specified time allowance is inconsistent with scheduling data entered by the user. Identified conflicts can be resolved internally, and automatically, within the policy engine 500 according to established protocols, or referred out to a user for resolution. Where a conflict is resolved internally, a notification may be provided to an administrator or log file as to the specific conflict identified, the resolution, and the data and time the resolution was taken. User-resolved conflicts may be similarly handled. Once any conflicts have been resolved, a backup workflow and backup schedule can be generated. In some instances, one or both of a backup workflow and backup schedule can be generated even if there is an unresolved conflict.

With continued reference to FIG. 5, the policy engine 500 may further include a workflow generator 510. In general, the workflow generator 510 uses the guidelines developed by the analyzer 506 to generate a specific workflow consistent with the input parameters. In at least some embodiments, a workflow can include a sequence of processes which, when performed by one or more agents and/or at the direction of one or more agents, will effect the backup of an identified cluster element or elements, such as a node for example, and/or identified data. One example of such an agent is the cluster agent 140. Some specific examples of backup processes that can be performed in accordance with a workflow generated by the policy engine 500 are disclosed elsewhere herein.

As further indicated in FIG. 5, the policy engine 500 may include a scheduler 512 that evaluates the backup workflow developed by the workflow generator 510 and prepares a schedule for execution of that backup workflow. As part of this process, the scheduler 512 may take into account any combination of the input parameters disclosed herein. Examples of input parameters that may be particularly useful in connection with the operation of the scheduler 512 include information about data flow and usage at elements such as cluster nodes, including VMs, and CSVs. Among other things, such information may specifically include one or more of availability information concerning when and for how long an element has been available for access, peak usage times, peak data access rates, peak user numbers, low usage times, low data access rates, low user numbers, network down times and durations, schedule times and durations for other backups, the type or types of data accessed and the frequency with which such data is accessed, the amount of data stored, when data was stored, the amount of data deleted, and, when data was deleted

By evaluating and taking into account various input parameters, such as one or more of those noted above, the scheduler 512 can determine the time and/or length of window for performing a backup process. In some instances at least, the time and/or length of the window may be optimal in view of constraints set forth in the user parameters. In other instances, the scheduler 512 can determine that there are multiple backup windows that are consistent with the relevant user parameters. In this circumstance, the scheduler 512 may have autonomy to pick a backup window without user input, or the scheduler 512 can identify the different backup windows to a user so that a user can select a particular backup window. Moreover, some embodiments of the scheduler 512 may use historical data, such as that discussed above in connection with the database 410, to predict a best time to perform one or more particular backups and/or to predict the length of a particular backup. The predicted time may, but need not, be used to schedule a backup.

In any case, the scheduler 512 may include a clock, or access to clock information, so that when the start time for a particular backup comes, that backup will commence. In at least some embodiments, a backup may commence automatically upon arrival of the backup start time. As well, a user may be presented, such as by way of UI 504 for example, a list of one or more of scheduled, running, and completed backups.

With continued reference to the scheduler 512 and workflow generator 510, at least some embodiments of the policy engine 500 may include, or be configured to access, a library 514. The library 514, which may be located remotely from the policy engine 500, may store one or more backup workflows and associated schedules. The stored backup workflows and associated schedules are accessible by the agent or other entity that is performing and/or directing backups in the operating environment 400. Among other things, the stored backup workflows and associated schedules may be retrieved from the library 514 and re-used if circumstances permit, and can therefore obviate the need, in some instances at least, to develop a new backup workflow and associated schedule. The library 514 may be particularly useful where it is expected that one or more particular backups will be performed on a regular basis.

It was noted earlier that an aspect of some embodiments of the invention concerns the ability of the of a policy engine to dynamically adjust the workflow of a backup process ‘on the fly’ to accommodate changes in one or more conditions, such as the failover of a node for example, in the environment where the backup is being performed. Accordingly, at least some embodiments of the policy engine 500 include a monitor 516 that is operable to monitor the operating environment 400 and detect, or receive information concerning, conditions in the operating environment 400. When a change in condition occurs that corresponds to a change in a value of one or more of the input parameters initially used to define the workflow for the backup that was in progress at the time of the change in condition, information concerning that change in condition can be provided by the monitor 516 to one or more of the analyzer 506, conflict module 508, workflow generator 510, and scheduler 512, so that the backup workflow and/or backflow schedule can be modified in a way that is responsive to the detected change in condition.

Finally, and with continued reference to FIG. 5, the policy engine 500 may also include a reporting module 518. In general, the reporting module 518 may gather and provide information to a user and/or others concerning any aspect(s) of the operation of the policy engine 500. The information may be provided contemporaneously with the occurrence of a particular event and/or may be stored for later access. Information provided by the reporting module 518 may, but need not, be formatted in a way that is consistent with the expected use and/or users of the information.

Some particular examples of information that may be gathered and reported by the reporting module 518 include, but are not limited to, information concerning: the state of a backup that is in-progress; problems that may have occurred during a backup; backups that were not started, or completed, for some reason; modifications that were made to a backup workflow and/or backflow schedule in response to a detected change in condition in the operating environment; and, when a backup was started and/or completed. Any of the foregoing may serve as input parameters for new and/or modified policies.

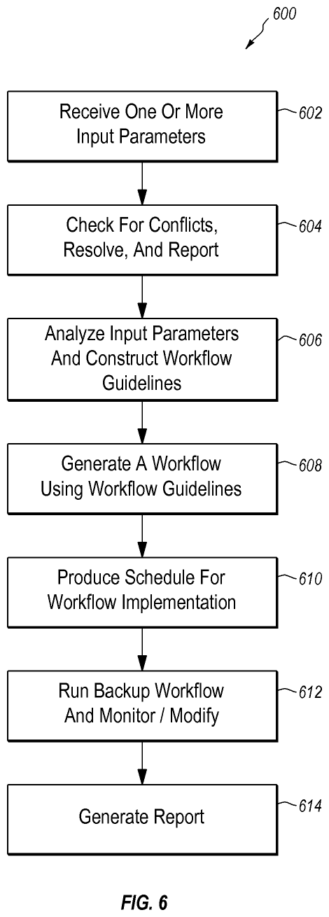

Turning now to FIG. 6, details are provided concerning an example of a process 600 that may be implemented in connection with a policy engine, such as policy engine 500 for example. While FIG. 6 indicates various processes performed in a particular order, the scope of the invention is not limited to the depicted group of processes, nor to the order in which they are depicted as being performed. Moreover, it will be appreciated that the process 600 can be modified to include different and/or more functionality, including any combination of the functionalities disclosed herein as being associated with a policy engine and/or one or more of its elements and modules.

At 602, one or more input parameters concerning a backup are received. The input parameters may be any combination of the example input parameters disclosed herein. At 604, the input parameters are checked for conflicts and any identified conflicts are resolved. The conflicts and their resolution may also be reported as part of 604. At 606, the input parameters are then analyzed and used to construct workflow guidelines that can be used in the development of a backup workflow.

Next, a workflow is generated 608 using the workflow guidelines developed at 606. When the workflow has been generated, a schedule can then be produced 610 for the implementation of that workflow. In connection with production of the schedule, a start time and duration of the associated workflow may be established. As noted herein, the schedule may be configured so that the associated backup begins automatically.

At 612, the backup workflow is run. The backup may be monitored, and dynamically modified, while it is in progress. Finally, upon completion or other termination of the workflow, a report may be generated 614 concerning the workflow and any related conditions or events.

The embodiments disclosed herein may include the use of a special purpose or general-purpose computer including various computer hardware or software modules, as discussed in greater detail below. Among other things, any of such computers may include a processor and/or other components that are programmed and operable to execute, and/or cause the execution of, various instructions, such as the computer-executable instructions discussed below.

Embodiments within the scope of the invention may also include the use of a special purpose or general-purpose computer including various computer hardware or software modules, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
receiving one or more input parameters;
analyzing the input parameters and constructing a set of policies based upon the analysis of the input parameters;
generating a backup workflow for performing a backup, wherein the backup workflow is based on the policies, and wherein the backup workflow comprises a group of processes which, when the group of processes is performed, result in the backup of data of an entity;
generating a schedule for implementation of the backup workflow; and
running the backup workflow according to the schedule so that a backup of a computing entity in the computing environment is created during a backup interval, wherein the computing environment includes a cluster of nodes, wherein running the backup workflow is performed by a cluster agent, and the cluster agent is operable to determine a location of the computing entity in the computing environment by performing a query of the computing environment, and the cluster agent is node failure tolerant so that upon failure of a node on which the cluster agent resides, the cluster agent moves from the failed node to another node of the computing environment,
wherein the backup workflow is run notwithstanding that a backup entity performing the backup is unaware of a location of the computing entity that is being backed up,
wherein the cluster agent is a cluster resource and has an IP address separate from names and IP addresses of nodes in the cluster such that the backup entity can contact the cluster agent without being aware of the node or of an address of the node on which the cluster agent operates in the cluster.

2. The method as recited in claim 1, wherein the computing entity that is backed up is a virtual machine of the computing environment.

3. (canceled)

4. The method as recited in claim 1, wherein the cluster agent is available for running the backup workflow during the backup interval notwithstanding the occurrence, prior to the backup interval, of a failure of a node where the cluster agent was located at the time of the failure.

5. The method as recited in claim 1, wherein the set of policies is an element of the cluster agent.

6. The method as recited in claim 1, wherein the input parameters include information about the physical configuration of an element of the computing environment.

7. The method as recited in claim 1, wherein the input parameters include information about the state of an element of the computing environment.

8. The method as recited in claim 1, wherein the input parameters include historical information about a previously performed backup operation.

9. The method as recited in claim 1, wherein the schedule is based upon a prediction of future data flow between two or more elements of the computing environment.

10. The method as recited in claim 1, wherein the schedule is based upon information concerning a previously performed backup operation.

11. The method as recited in claim 1, further comprising analyzing the input parameters for conflicts, and resolving any identified conflicts.

12. The method as recited in claim 1, further comprising modifying the backup workflow, while the backup workflow is running, in response to a detected change in the computing environment.

13. A non-transitory storage medium having stored therein instructions which are executable by one or more hardware processors to perform operations comprising:
receiving one or more input parameters, wherein the input parameters include historical information concerning a previously performed backup, and further include user-supplied input parameters;
analyzing the input parameters and constructing a set of policies based upon the analysis of the input parameters;
generating a backup workflow for backing up a virtual machine in a cluster based on the policies, the cluster includes nodes;
generating a schedule for implementation of the backup workflow; and
running, by a cluster agent, the backup workflow according to the schedule so that a backup of the virtual machine in the cluster is created during a backup interval, wherein the backup of the virtual machine is created notwithstanding that a location of the virtual machine during the backup interval is unknown to a backup server that directs the cluster agent to run the backup workflow, but the location of the virtual machine during the backup interval is known to the cluster agent
wherein the cluster agent is a cluster resource and has an IP address separate from names and addresses of nodes in the cluster such that the backup server can contact the cluster agent without being aware of the node or of an address of the node on which the cluster agent operates in the cluster.

14. The non-transitory storage medium as recited in claim 13, wherein the backup workflow commences automatically at a predetermined time.

15. The non-transitory storage medium as recited in claim 13, wherein the backup of the virtual machine is not adversely affected if the virtual machine migrates to another node between the time that the backup of the virtual machines is scheduled and the time at which the backup of the virtual machine is performed.

16. The non-transitory storage medium as recited in claim 13, wherein the operations further comprise reporting regarding performance of the backup workflow.

17. The non-transitory storage medium as recited in claim 13, wherein the operations further comprise storing the backup workflow and schedule in a library.

18. The non-transitory storage medium as recited in claim 13, wherein the operations further comprise generating an additional schedule for implementation of the backup workflow, and presenting the schedule and additional schedule to a user for selection.

19. The non-transitory storage medium as recited in claim 13, wherein the operations further comprise analyzing the input parameters for conflicts, and resolving any identified conflicts.

20. The non-transitory storage medium as recited in claim 13, wherein the input parameters comprise one or more of cluster disk geometry and size, number of cluster nodes and their states, number of CSVs and their states, number of parallel backups permitted, number of online and offline virtual machines, throughput of a prior backup operation, elapsed time of a prior backup operation, local cache hit of a prior backup operation, and time allowance to perform the backup workflow.

21. A non-transitory storage medium having stored therein instructions which are executable by one or more hardware processors to perform operations comprising:
receiving one or more input parameters;
analyzing the input parameters and constructing a set of policies based upon the analysis of the input parameters;
generating a backup workflow for performing a backup, wherein the backup workflow is based on the policies, and wherein the backup workflow comprises a group of processes which, when the group of processes is performed, result in the backup of data of a computing entity;
generating a schedule for implementation of the backup workflow; and
running the backup workflow according to the schedule so that a backup of a computing entity in the computing environment is created during a backup interval, wherein the computing environment includes a cluster of nodes, wherein running the backup workflow is performed by a cluster agent, and the cluster agent is operable to determine a location of the computing entity in the computing environment by performing a query of the computing environment, and the cluster agent is node failure tolerant so that upon failure of a node on which the cluster agent resides, the cluster agent moves from the failed node to another node of the computing environment,
wherein the cluster agent is a cluster resource and has an IP address separate from names and addresses of nodes in the cluster such that a backup entity can contact the cluster agent without being aware of the node or of an address of the node on which the cluster agent operates in the cluster.

22. A physical device, wherein the physical device comprises:
one or more hardware processors; and
the non-transitory storage medium as recited in claim 21.

23. (canceled)
